(19) United States
(12) Patent Application Publication
(10) Pub. No.: US 2026/0011096 A1
(43) Pub. Date: Jan. 8, 2026

(54) DISPLAY OBJECT DETERMINATION METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventor: Yunhao Liao, Beijing (CN)

(21) Appl. No.: 18/869,600

(22) PCT Filed: May 25, 2023
(86) PCT No.: PCT/CN2023/096151

§ 371 Date: Nov. 26, 2024

(30) Foreign Application Priority Data
May 27, 2022 (CN) 202210593822.X

(51) Int. Cl. G06T 19/20; G06V 10/77

(52) U.S. Cl. CPC G06T 19/20; G06V 10/7715

(57) ABSTRACT

Provided in embodiments of the disclosure are a method, apparatus, electronic device, and storage medium for determining a display object. The method comprises: determining at least one part feature recognition parameter of a target object; determining a target component corresponding to the at least one part feature recognition parameter and display information of the target component, wherein a part type of the target component corresponds to a target part type in the part feature recognition parameter; determining a virtual object to be adjusted corresponding to the target object by splicing at least one target component; and determining a target virtual object based on display information of the at least one target component and the virtual object to be adjusted and displaying the target virtual object.

The disclosure claims the priority to Chinese Patent Application No. 202210593822.X, filed with the Chinese Patent Office on May 27, 2022, which is incorporated in its entirety herein by reference.

### FIELD

Embodiments of the disclosure relate to a computer software technology, and relate to a display object determination method and apparatus, electronic device and storage medium, for example.

### BACKGROUND

In order to enrich the display of an object in a video or an image, the object in the video or image can be modeled and displayed as a model object. For example, a person can be transformed into a virtual building block model of granular or blocky elements.

In a process of virtualizing and displaying objects, it is a waste of time and resources to re-recognize an object every time and re-construct a model object every time. In a case where various virtual models are pre-constructed and stored, a problem of insufficient model diversity and a large occupancy of storage will be caused.

### SUMMARY

The disclosure provides a display object determination method, apparatus, electronic device and storage medium to save the storage and improve the model diversity, and then improve the user experience.

In a first aspect, a method for determining a display object is provided in an embodiment of the disclosure. The method comprises:
determining at least one part feature recognition parameter of a target object;
determining a target component corresponding to the at least one part feature recognition parameter and display information of the target component, wherein a part type of the target component corresponds to a target part type in the part feature recognition parameter;
determining a virtual object to be adjusted corresponding to the target object by splicing at least one target component; and
determining a target virtual object based on display information of the at least one target component and the virtual object to be adjusted and displaying the target virtual object.

In a second aspect, an apparatus for determining a display object is further provided in an embodiment of the disclosure. The apparatus comprises:
a parameter determination module configured to determine at least one part feature recognition parameter of a target object;
a component determination module configured to determine a target component corresponding to the at least one part feature recognition parameter and display information of the target component, wherein a part type of the target component corresponds to a target part type in the part feature recognition parameter;
a component splicing module configured to determine a virtual object to be adjusted corresponding to the target object by splicing at least one target component; and
a display module configured to determine a target virtual object based on display information of the at least one target component and the virtual object to be adjusted and to display the target virtual object.

In a third aspect, an electronic device is further provided in an embodiment of the disclosure. The electronic device comprises:
at least one processor; and
a storage apparatus configured to store at least one program; wherein

the at least one program, when executed by the at least one processor, causes the at least one processor to implement any method for determining a display object in the embodiment of the disclosure.

In a fourth aspect, a storage medium containing a computer program is further provided in an embodiment of the disclosure. The computer program executes any method for determining a display object in the embodiment of the disclosure when executed by a computer processor.

### BRIEF DESCRIPTION OF THE DRAWINGS

FIG. 1 is a schematic flowchart of a method for determining a display object according to an embodiment of the disclosure;

FIG. 2 is a schematic flowchart of another method for determining a display object according to an embodiment of the disclosure;

FIG. 3 is a schematic diagram of an image to be processed and a target virtual object according to an embodiment of the disclosure;

FIG. 4 is a schematic structural diagram of an apparatus for determining a display object according to an embodiment of the disclosure; and

FIG. 5 is a schematic structural diagram of an electronic device according to an embodiment of the disclosure.

### DETAILED DESCRIPTION OF EMBODIMENTS

The terms “comprise” and “comprise” used herein and their variations are open-ended, that is, “comprise but not limited to” and “comprise but not limited to”. The term “based on” means “at least partly based on”. The term “an embodiment” means “at least one embodiment”. The term “another embodiment” means “at least another embodiment”. The term “some embodiments” means “at least some embodiments”. Related definitions of other terms will be given in the following description.

It should be noted that concepts such as “first” and “second” mentioned in the disclosure are only used to distinguish different apparatuses, modules or units, and are not used to limit an order or interdependence of functions executed by the apparatuses, modules or units.

It should be noted that modification with “a”, “an” or “a plurality of” mentioned in the disclosure is illustrative rather than limitative, and should be understood by those skilled in the art as “one or more” unless explicitly stated otherwise in the context.

Names of messages or information exchanged between a plurality of apparatuses in the embodiment of the disclosure are only for illustrative purposes, instead of limiting the scope of the messages or information.

It can be understood that before usage of the technical solution disclosed in embodiments of the disclosure, a user has to be informed about a type, a use scope, a use scene, etc. of personal information involved in the disclosure in an appropriate way in accordance with relevant laws and regulations and user authorization has to be obtained.

For instance, in response to receiving an active request of a user, prompt information is transmitted to the user, so as to clearly remind the user that an operation requested by the user is about to obtain and use personal information of the user. Therefore, the user can independently choose to provide or not provide the personal information to software or hardware such as an electronic device, an application, a server or a storage medium that executes an operation of the technical solution of the disclosure according to the prompt information.

As an optional and non-limitative embodiment, in response to receiving the active request of the user, a mode of transmitting the prompt information to the user can be, for instance, a pop-up window mode, in which the prompt information can be presented in a character form. In addition, the pop-up window can further carry a selection control allowing the user to choose to “agree” or “disagree” to provide the personal information to the electronic device.

It can be understood that the above process of informing and obtaining user authorization is only illustrative, and does not limit the embodiment of the disclosure. Other modes satisfying relevant laws and regulations can also be applied to the embodiment of the disclosure.

Before the technical solutions are introduced, the application scenario can be illustratively described first. The technical solutions according to the embodiments of the disclosure can be applied to any scenario where a target object is required to be modeled or virtualized. For example, in a process of generating an object model, the technical solutions according to the embodiments of the disclosure can be employed for modeling. The technical solutions according to the embodiments of the disclosure can be employed when the target object is required to be modeled in scenarios such as short video shooting, video call, and video live broadcast. It should also be noted that after an image is collected, the technical solutions according to the embodiments of the disclosure are used for processing the image.

An apparatus for executing a method for determining a display object according to an embodiment of the disclosure may be integrated in application software supporting an effect image processing function. The software may be installed in an electronic device. Optionally, the electronic device may be a mobile terminal, a personal computer (PC) terminal, etc. The application software may be a type of software for image/video processing, which will not be repeated herein, as long as image/video processing can be implemented.

In the embodiments of the disclosure, a timing for determining to collect an image to be processed comprising a target object comprises at least one of the following: an effect prop used for triggering object modeling is detected; collected audio information is detected as triggering an effect awakening word; a frame-in image is detected as comprising a target object; and a limb action of a target object is detected as being consistent with a preset limb action.

The effect prop may be triggered through a button displayed on a display interface of the application software. The trigger of the button indicates the requirement of determining a modeled virtual object. In practical application, if the user triggers the button, the image to be processed collected is required to be processed.

Alternatively, voice information may be collected based on a microphone array deployed on the terminal device and analyzed. If a processing result comprises a word for performing modeling, it is indicated that a function of the modeling processing is triggered. The advantage of determining whether to perform the modeling processing based on content of the voice information lies in that interaction between the user and the display interface is avoided, and smartness of the modeling processing of the target object is improved. In another embodiment, whether a shooting visual field range of a mobile terminal comprises a facial image of the user may be determined. When the facial image of the user is detected, the application software may take the event of detecting the facial image as an operation of collecting the image to be processed. Alternatively, it can be triggered when an object in a frame-in image is detected as triggering an action of collecting an image to be processed corresponding to modeling processing, for example, an “OK” gesture. Those skilled in the art should understand that what event is selected as a trigger condition for collecting the image to be processed in the modeling processing may be set according to actual conditions, which will not be limited in the embodiments of the disclosure.

At present, pre-designed models may be stored in a prop table. If a storage space of a prop package is preset, and various models are stored in the prop package, it may be impossible to store all the models, leading to few model styles and undesirable user experience. If the storage space of the prop package is expandable, the storage space of the prop package may occupy a large memory size, and thus cannot be applicable in terminal devices with various memory sizes.

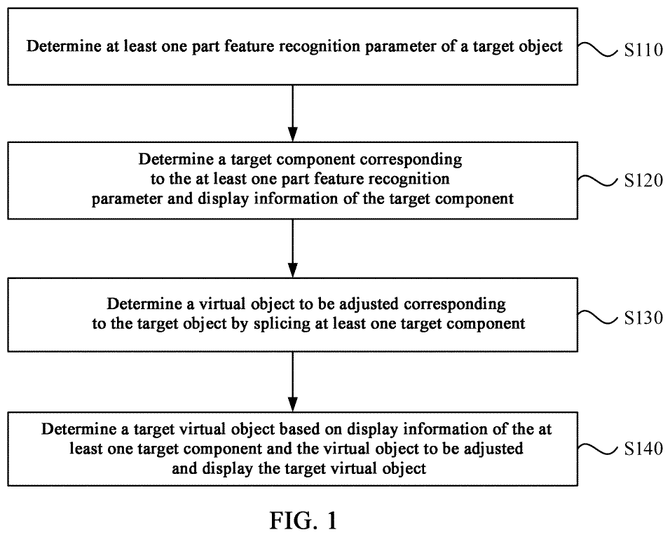

FIG. 1 is a schematic flowchart of a method for determining a display object according to an embodiment of the disclosure. The embodiment of the disclosure is applicable to a situation where a virtual image simulating a target object is generated according to the target object. The method may be executed by an apparatus for determining a display object. The apparatus may be implemented through at least one of software and hardware. Optionally, the apparatus may be implemented through an electronic device, which may be a mobile terminal, a PC terminal, or a server, etc.

As shown in FIG. 1, the method comprises:

S110, at least one part feature recognition parameter of a target object is determined.

The target object may be an object to be modeled and displayed, for example, a person or an animal. The part feature recognition parameter may be a parameter configured to describe a feature of at least one part of the target object. Optionally, the part feature recognition parameter corresponds to a corresponding part and part feature, the part comprises any part of a head or a limb, and the part feature comprises a wearing feature, a color feature, and a texture feature.

Illustratively, after being determined, the target object may be recognized to directly determine the part feature recognition parameter corresponding to at least one part of the target object. Alternatively, at least one part of the target object may be determined first, then the at least one part may be recognized individually to determine the part feature recognition parameter corresponding to the at least one part.

S120, a target component corresponding to the at least one part feature recognition parameter and display information of the target component are determined.

The target component may be a component corresponding to the part, and the target component is configured to be spliced into a target virtual object subsequently. The part feature recognition parameter may comprise a target part type describing the corresponding part. A part type of the target component corresponds to a target part type in the part feature recognition parameter. For example, the target component is a head component and the part type is the head, etc. The display information may be parameter information used for adjusting the target component subsequently when the target component is displayed. For example, the display information may comprise color information, texture information, transparency information, etc.

Illustratively, according to the at least one part feature recognition parameter, a program code or description file, such as a json file, corresponding to the at least one part feature recognition parameter and configured to construct the target component may be determined. Further, the target component may be constructed according to the program code or description file determined, and the display information for displaying the target component may also be determined subsequently.

Illustratively, the program code may be pre-written, and the program code contains program segments corresponding to various part feature recognition parameters. The determined part feature recognition parameters may be executed sequentially in the program code. When a matched program segment is determined, parameter information for constructing the target component, for example, positions, rotation angles, sizes, and display parameters of a plurality of elements, is obtained from the program segment. The elements are a plurality of members configured to constitute the target component. According to the parameter information, the plurality of elements may be adjusted and spliced to obtain the target component, and the display information of the target component is determined.

It should be noted that a plurality of components may be pre-designed. These components are automatically parsed through a script, and the description files are constructed for the output components. As such, one description file is constructed for each component, one description file is constructed for the components of each part, or one description file is constructed for the components of the plurality of parts.

S130, at least one target component is spliced to determine a virtual object to be adjusted corresponding to the target object.

The virtual object to be adjusted may be a virtual object obtained by splicing the target components, that is, a virtual object corresponding to the target object obtained from the preliminary processing.

Illustratively, after the at least one target component is obtained, a splicing parameter of the at least one target component, such as a splicing position and a splicing angle, may be determined. Further, the at least one target component may be adjusted according to the splicing parameter. After being adjusted, the at least one target component may be deemed as being spliced. Further, a component set obtained by splicing the at least one target component is considered as the virtual object to be adjusted.

S140, a target virtual object is determined based on display information of the at least one target component and the virtual object to be adjusted and then is displayed.

The target virtual object may be a virtual object determined after being adjusted based on the display information, i.e., a virtual object configured to correspond to the target object. The target virtual object may be understood as a building block image that is formed by splicing at least one granular or blocky element and has the same state as the target object.

Illustratively, according to the display information of the at least one target component, the display parameter of the at least one target component in the virtual object to be adjusted may be adjusted to make the display effect of the virtual object to be adjusted closer to the target object. Further, the virtual object to be adjusted after the display parameter is adjusted is considered as the target virtual object and displayed as the target virtual object. According to the technical solution in the embodiment of the disclosure, the at least one part feature recognition parameter of the target object is determined to extract the feature of the at least one part of the target object. The target component corresponding to the at least one part feature recognition parameter and the display information of the target component are determined, so as to obtain the at least one component for subsequent splicing and the display information required for displaying these components. The at least one target component is spliced to determine a virtual object to be adjusted corresponding to the target object, such that the target components are spliced and combined to obtain an initial virtual object. The target virtual object is determined based on the display information of the at least one target component and the virtual object to be adjusted and then is displayed. In this way, the problem of a large storage occupancy and a lack of adaption to terminal devices with various memories in the process of determining the target virtual object is solved. The storage space is saved, the model diversity is improved, and the user experience is improved.

Based on the embodiment disclosed above, there may be a case where the display information corresponding to some part feature recognition parameter cannot be obtained or fails to be obtained. In such case, the corresponding target component may not be filled, resulting in an undesirable display effect of the target virtual object. In this case, the display information of the target part corresponding to the part feature recognition parameter may be determined according to a preset dependency relation, so as to obtain the display information in a fallback way, and thus the display effect of the virtual object is improved. This fallback way may be as follows:
when the part feature recognition parameter comprises the display information, the display information is obtained; and
when the part feature recognition parameter does not comprise the display information, an associated part type associated with the target part type in the part feature recognition parameter is determined, so as to determine display information of the target part type according to a part feature recognition parameter of the associated part type.

The associated part may be a part having an association relation with the target part, and the association relation may be determined based on pre-established part association information. Optionally, part association information may further comprise a relation between the display information of the target part type and the display information of the associated part type. For example, the display information of the target part type is consistent with the display information of the associated part type, and alternatively, the display information of the target part type undergoes preset adjustment based on the display information of the associated part type. The association relation may also be understood as a relation in body structure or a relation in dress. For example, the relation in limb structure may be that a part associated with the head is an arm, etc. The relation in dress may be understood as that the dress is generally matched one another, for example, a color of pants will be matched with a color of a coat.

Illustratively, the display information may be obtained from the part feature recognition parameter when the part feature recognition parameter comprises the display information. When the part feature recognition parameter does comprise the display information, missing display information is supplemented in order to improve the display effect of the target virtual object. The target part type corresponding to the part feature recognition parameter may be determined first, and then the associated part type associated with the target part type may be determined. For example, the associated part type may be determined through the pre-established part association relation. After the associated part type associated with the target part type is determined, the display information of the associated part type may be determined according to the part feature recognition parameter of the associated part type. According to the display information of the associated part type, the preset adjustment or copying, etc. may be performed so as to obtain the display information of the target part type. As such, undetermined display information is supplemented, so as to improve the subsequent display effect of the target virtual object.

Illustratively, self_determine may represent the display information of the target part type having the associated part type, and the display information can be determined only after the display information of the associated part type is confirmed.

It should be noted that the part association relation may be hierarchical. For example, neither part A nor part B has display information, but it may be determined that the part association relation is that part A is associated with part B and part B is associated with part C. In this case, it is required to determine the display information of part C first. Display information of part B is determined according to the display information of part C. Further, display information of part A is determined according to the display information of part B.

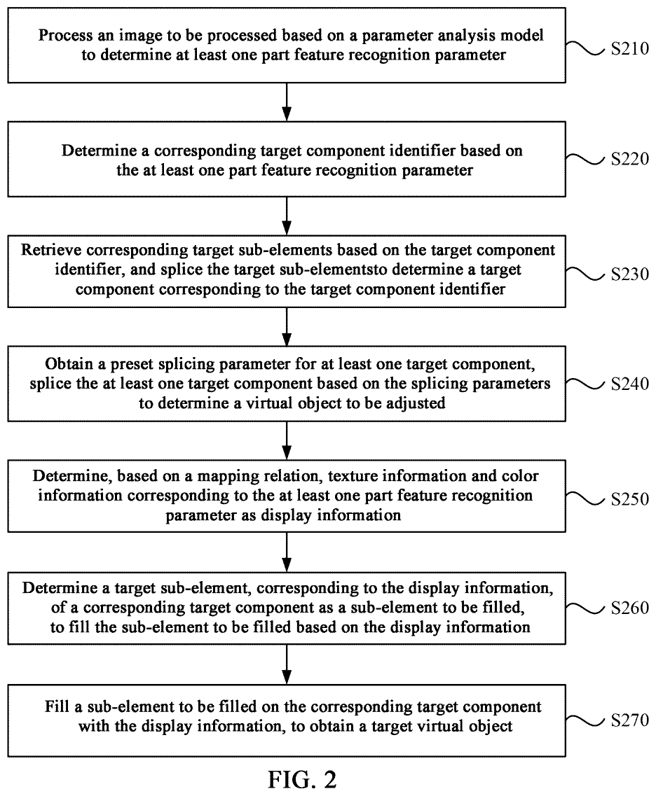

FIG. 2 is a schematic flowchart of another method for determining a display object according to an embodiment of the disclosure. Based on the embodiment disclosed above, embodiments of obtaining a part feature recognition parameter, determining a target component, splicing target components, and displaying a target virtual object can be made reference to the detailed description of the technical solution. The explanations of terms identical or corresponding to those in the technical solution above will not be repeated herein.

As shown in FIG. 2, the method comprises:

S210, an image to be processed is processed based on a parameter analysis model to determine at least one part feature recognition parameter.

The image to be processed may be an uploaded, downloaded, or shot image to undergo virtual object processing, and the image to be processed comprises a target object. The parameter analysis model may be a model pre-trained and configured to extract the part feature recognition parameter, e.g., a machine learning model, etc. The model type may be set as demanded.

Illustratively, the image to be processed is obtained and input into the parameter analysis model, so that the parameter analysis model analyzes and processes the image to be processed. An output result of the parameter analysis model is taken as at least one part feature recognition parameter corresponding to the image to be processed. Accordingly, at least one part feature recognition parameter of the target object is extracted from the image to be processed rapidly and accurately.

Illustratively, the part feature recognition parameter may be recorded through a key-value pair. A part type may be taken as key information, and a part feature recognition parameter corresponding to the part type may be taken as value information.

S220, a corresponding target component identifier is determined based on the at least one part feature recognition parameter.

The target component identifier may be an identifier configured to distinguish different components corresponding to the part type, and may be an identifier corresponding to the part feature recognition parameter.

Illustratively, the part type corresponding to the part feature recognition parameter may be determined first. Further, a component identifier corresponding to the part feature recognition parameter is searched for according to the part type and determined as the target component identifier. As such, components of different parts can be searched for easily and distinguished from one another.

Illustratively, in a pre-written program code, the part type may be matched first. Further, the part feature recognition parameter is matched with component identifiers sequentially under the part type. When the part feature recognition parameter is matched with a component identifier successfully, the component identifier that is matched successfully is determined as the target component identifier.

Optionally, when the program code is written using conditional statements to determine the target component identifier, there may be a problem of low robustness and a lack of extensibility, readability and maintainability. Therefore, the program code may be written using non-conditional statements based on a mapping relation, so as to determine the target component identifier as follows:

the target component identifier corresponding to the at least one part feature recognition parameter is determined based on the pre-established mapping relation.

The mapping relation may be a relation pre-designed and pre-established by a designer determining the parameter information for different parts and optional branches under different parts according to a designed virtual model. For example, the mapping relation may be in a form of a relation graph, a relation table, a relation tree, etc. The mapping relation comprises the part type and the component identifier of at least one display state associated with the part type. The part feature recognition parameter comprises the target part type and a corresponding target display state. The display state may be a state used for distinguishing between different features of the parts. For example, a display state of hair may comprise wearing a cap and wearing no cap. A display state of wearing a cap may be subdivided into states of various types of caps, such as a peaked cap, a cowboy cap, and a bowler cap. The mapping relation may comprise the pre-established part type and component identifiers of various display states corresponding to each part type.

Illustratively, the program code corresponding to the mapping relation may be determined based on the pre-established mapping relation. Further, the component identifier is searched for according to the at least one part feature recognition parameter through the program code, so as to determine the corresponding target component identifier.

Illustratively, the mapping relation may be in a format as follows: part type: cap, “component name: none, component identifier: 0, and feature name: no cap”; “component name: CAP_yashemao, component identifier: 1, and feature name: peaked cap”; “component name: CAP_yashemao, component identifier: 7, and feature name: octagonal beanie cap”; “component name: CAP_yuandingmao, component identifier: 3, and feature name: cowboy cap”; “component name: CAP_yuandingmao, component identifier: 5, and feature name: flat-topped round-edged cap”; “component name: CAP yufumao, component identifier: 4, and feature name: fisherman cap”, etc. A program corresponding to the mapping relation may be determined through mapping information provided by the mapping relation. The component of a current part type may be determined automatically through an algorithm result by analyzing the mapping relation. The program code may enable the part feature recognition parameter to correspond to the mapping relation through an algorithm, and the component identifier finally determined through the algorithm result is taken as the target component identifier. Optionally, in order to improve the search performance, a binary search method may be used to conduct the correspondence between the part feature recognition parameter and the mapping relation.

S230, corresponding target sub-elements are retrieved based on the target component identifier, and the target sub-elements are spliced to determine the target component corresponding to the target component identifier.

The target sub-elements may be sub-elements corresponding to the target component identifier and configured to construct the target component. Optionally, the target sub-element of the target component is at least one of a granular element or a blocky element.

Illustratively, a plurality of target sub-elements corresponding to the target component identifier may be determined according to the target component identifier. The plurality of target sub-elements may be automatically spliced according to a predetermined position. A combination obtained by splicing the plurality of target sub-elements may be taken as the target component corresponding to the target component identifier. The target component may be detailed through the method above. The target sub-elements are spliced and combined. Therefore, the problem that a large storage space is occupied by a direct storage of various components is avoided, and the storage space is saved.

Optionally, a sub-element splicing parameter may be preset for the sub-elements, so as to splice the target sub-elements according to the sub-element splicing parameter conveniently and rapidly. An example is as follows:

the preset sub-element splicing parameter corresponding to the target sub-elements is obtained; and the corresponding target sub-elements are spliced based on the sub-element splicing parameter of the target sub-elements to obtain the target component.

The sub-element splicing parameter may be a parameter corresponding to the sub-element and configured for splicing, or may be a correlated parameter between the plurality of sub-elements. The sub-element splicing parameters comprise a rotation parameter, a position parameter, and a size parameter. The rotation parameter may be an angle parameter of the sub-elements in space. The position parameter may be relative position information or absolute position information corresponding to centers of the sub-elements. The size parameter may be a parameter configured to describe a size of the sub-elements.

Illustratively, after the target sub-elements are determined, the preset sub-element splicing parameter corresponding to the target sub-elements may be obtained according to the target sub-elements. Further, the target sub-elements may be adjusted and processed according to the relevant sub-element splicing parameter. After all the target sub-elements are adjusted and processed, a resulting set of the target sub-elements is taken as the target component obtained through splicing.

S240, a preset splicing parameter of the at least one target component is obtained, the at least one target component is spliced based on the splicing parameter to determine a virtual object to be adjusted.

The splicing parameter may be a parameter corresponding to the component and configured for splicing. The splicing parameter comprises a rotation parameter, a position parameter, a size parameter, etc.

Illustratively, after the at least one target component is determined, the preset splicing parameter corresponding to the target component may be obtained according to the at least one target component. Further, each target component may be adjusted and processed according to the corresponding splicing parameter. After each target component is adjusted and processed, a target component set obtained is taken as the virtual object to be adjusted obtained through splicing. In this way, the at least one target component may be accurately spliced, so that the virtual object to be adjusted is rapidly obtained.

S250, texture information and color information corresponding to the at least one part feature recognition parameter is determined as display information based on the mapping relation.

The texture information may be information describing a non-pure-color pattern, and may comprise textures, or lines, etc. The color information may be information describing a color, saturation, transparency, etc. The mapping relation comprises the color information and the texture information corresponding to the part feature recognition parameter.

Illustratively, the texture information and the color information corresponding to the part feature recognition parameter may be found from the mapping relation though searching according to the part feature recognition parameter. The texture information and color information is integrated as the display information corresponding to the at least one part feature recognition parameter, i.e., the display information of the target component.

Illustratively, the display information may be in a form of a key-value pair. For example, the color information may be black—0; dark gray—1; dark brown—2; brown—3; tan—4, etc. Optionally, default display information may be preset. For example, a component corresponding to a skin portion is in a default skin color. Optionally, the display information corresponding to the at least one part feature recognition parameter and a priority of preset default display information may also be set. For example, when the priority of the preset default display information is high, even if the display information is determined according to the at least one part feature recognition parameter, the preset default display information will overwrite the display information determined.

It should be noted that S250 may be executed before or after S240, and S250 is only required to be executed before S260.

It should also be noted that the storage space can be saved and the display effect of the target component can be further enriched by storing the display information through the mapping relation.

S260, a target sub-element, corresponding to the display information, of a corresponding target component is determined as a sub-element to be filled and the sub-element to be filled is filled based on the display information.

The sub-element to be filled may be a target sub-element needs to be filled according to the display information, and the sub-element to be filled may be a target sub-element located on an outer side. The reason for this is that even if a target sub-element located on an inner side of the virtual object to be adjusted is filled according to the display parameter, it may not be displayed in the target virtual object displayed subsequently, resulting in a waste of calculation and storage resources.

Illustratively, the target sub-element required to be filled on the target component may be determined according to the display information of the target component. The target sub-element required to be filled is taken as the sub-element to be filled, so as to be filled subsequently.

S270, the sub-element to be filled of the corresponding target component is filled with the display information to obtain the target virtual object.

Illustratively, after the sub-element to be filled of the target component is determined, it may be filled according to the display information of the target component (in other words, filled with textures and colors). After the sub-element to be filled is filled according to the display information, the target virtual object may be obtained. As such, an outer surface of the target virtual object is filled according to the display information.

Based on the embodiment disclosed above, in order to improve the realism and attractiveness effect of the target virtual object, the part corresponding to the at least one part feature recognition parameter may be beautified. For example, if a parameter configured to determine whether to beautify the part corresponds to a true value, beautification is performed according to a preset beautification parameter. If a parameter configured to determine whether to beautify the part corresponds to a false value, no beautification is performed. An example is as follows:

the preset beautification parameter is obtained when a beautification instruction is received to perform beautification on the corresponding part based on the beautification parameter.

The beautification instruction may be an instruction configured to trigger a beautification effect, e.g., automatically or manually. The beautification parameter may be a parameter configured for beautification, and may comprise parameters of various beautification types, such as a whitening type and a neatening type. The automatic way may be understood as setting beautification parameters corresponding to different colors, part types, etc., and generating corresponding program codes in a design stage. As such, when the target object is collected, the virtual object to be adjusted may be beautified based on the program code to obtain the target virtual object. The manual trigger may be understood as that the beautification parameters may be preset for a plurality of part types. When a trigger operation executed by the user based on a beautification control in a display interface is detected, the preset beautification parameter may be added to a corresponding part feature recognition parameter to implement the beautification effect subsequently.

Illustratively, the at least one part feature recognition parameter may be determined to determine whether to beautify the part. For example, a parameter “need color beautify”, represented by “ncb”, is defined. If the parameter corresponds to a true value, it is indicated that color beautify is needed. Further, when it is determined to beautify the part corresponding to the at least one part feature recognition parameter, the preset beautification parameter related to beautification of the part is obtained, and the part is beautified according to the beautification parameter. Based on the embodiment disclosed above, if a target position contains no pattern element, the display effect is monotonous, and thus the target position may be processed with a sticker. The target position may be a preset position, such as clothes.

Illustratively, a preset number of randomly-generated sticker effects may be stored in a preset queue, and a length of the preset queue equals the preset number. When the target position in the target virtual object is detected as containing no pattern element, one sticker effect is obtained from the head of the preset queue, displayed at the target position, and deleted from the preset queue. If all the sticker effects are deleted from the preset queue, a preset number of sticker effects are randomly generated to fill the preset queue for subsequent processing with the sticker.

According to the technical solution in the embodiment of the disclosure, the at least one part feature recognition parameter is determined by processing the image to be processed through the parameter analysis model, so that the feature is extracted from the at least one part of the target object. The corresponding target component identifier is determined based on the at least one part feature recognition parameter. The corresponding target sub-elements are retrieved based on the target component identifier, the target sub-elements are spliced, and the target component corresponding to the target component identifier is determined, so that at least one component configured for subsequent splicing is obtained. The splicing parameter preset of the at least one target component is obtained, and the at least one target component is spliced based on the splicing parameter. The virtual object to be adjusted is determined, and the target component is spliced and combined, so as to obtain an initial virtual object. The texture information and the color information corresponding to the at least one part feature recognition parameter are determined as the display information based on the mapping relation, so that the display information required for displaying the target component is determined. The target sub-element, corresponding to the display information, of the corresponding target component is determined as the sub-element to be filled. The sub-element to be filled is filled based on the display information, and the sub-element to be filled of the corresponding target component is filled with the display information, so as to obtain the target virtual object. Therefore, the problem of a large storage occupancy and a lack of adaption to terminal devices with various memories in the process of determining the target virtual object is solved. The storage space is saved, the model diversity is improved, and the user experience is improved.

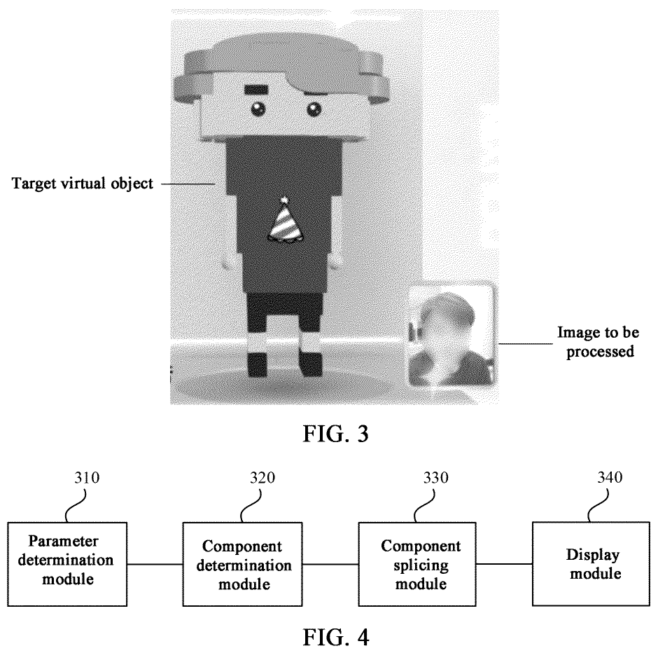

In order to clearly understand the effect implemented in the embodiments of the disclosure, the description may be made in conjunction with FIG. 3, where the image to be processed comprising the target object is shown in the lower right corner. The at least one part feature recognition parameter, for example, a head parameter comprising hairstyle-short hair, bangs-yes, etc., an upper limb parameter comprising clothes-short sleeve, color-black, etc., may be obtained by processing the image to be processed. It should be noted that the image to be processed contains no lower limb parameter, and may be supplemented with a preset default lower limb parameter. The target component corresponding to each part may be determined according to the obtained part feature recognition parameter, and the at least one target component is spliced and filled according to the display information to obtain the target virtual object.

It should be noted that the skin color may be a preset color parameter. When filling is performed according to the display information, the color parameter preset is directly retrieved for filling.

It should also be noted that when the target position in the image to be processed is between the clothes and without a pattern, the sticker effect located at the head of the preset queue may be taken out for filling, so as to enrich the display effect.

FIG. 4 is a schematic structural diagram of an apparatus for determining a display object according to an embodiment of the disclosure. As shown in FIG. 4, the apparatus comprises: a parameter determination module 310, a component determination module 320, a component splicing module 330, and a display module 340.

The parameter determination module 310 is configured to determine at least one part feature recognition parameter of a target object. The component determination module 320 is configured to determine a target component corresponding to the at least one part feature recognition parameter and display information of the target component, wherein a part type of the target component corresponds to a target part type in the part feature recognition parameter. The component splicing module 330 is configured to determine a virtual object to be adjusted corresponding to the target object by splicing at least one target component. The display module 340 is configured to determine a target virtual object based on display information of the at least one target component and the virtual object to be adjusted and display the target virtual object.

Optionally, the parameter determination module 310 is further configured to process an image to be processed based on a parameter analysis model, and determine the at least one part feature recognition parameter; where the image to be processed comprises the target object.

Optionally, the component determination module 320 is further configured to determine a corresponding target component identifier based on the at least one part feature recognition parameter, retrieve corresponding target sub-elements based on the target component identifier, and splice the target sub-elements to determine the target component corresponding to the target component identifier.

Optionally, the component determination module 320 is further configured to determine the target component identifier corresponding to the at least one part feature recognition parameter based on a pre-established mapping relation; where the mapping relation comprises the part type and a component identifier of at least one display state associated with the part type, and the part feature recognition parameter comprises the target part type and a corresponding target display state.

Optionally, the component determination module 320 is further configured to obtain preset sub-element splicing parameters and corresponding to the target sub-elements, wherein the sub-element splicing parameters comprise a rotation parameter, a position parameter, and a size parameter; and splice the corresponding target sub-elements based on the sub-element splicing parameters of the target sub-elements to obtain the target component.

Optionally, the component splicing module 330 is further configured to obtain a preset splicing parameter of the at least one target component, splice the at least one target component based on the splicing parameter to determine the virtual object to be adjusted.

Optionally, the apparatus further comprises: a display information determination module configured to determine, based on a mapping relation, texture information and color information corresponding to the at least one part feature recognition parameter as the display information; wherein the mapping relation comprises the color information and the texture information corresponding to the part feature recognition parameter.

Optionally, the apparatus further comprises: a sub-element to be filled determination module configured to determine a target sub-element, corresponding to the display information, of a corresponding target component as a sub-element to be filled to fill the sub-element to be filled based on the display information.

Optionally, the display module 340 is further configured to fill a sub-element to be filled on the corresponding target component with the display information to obtain the target virtual object.

Optionally, the apparatus further comprises: a display information determination apparatus configured to obtain the display information in a case where the part feature recognition parameter comprises the display information; and determine an associated part type associated with the target part type in the part feature recognition parameter in a case where the part feature recognition parameter does not comprise the display information, so as to determine display information of the target part type according to a part feature recognition parameter of the associated part type.

Optionally, the apparatus further comprises: a beautification module configured to obtain a preset beautification parameter in response to receiving a beautification instruction, so as to beautify a corresponding part based on the beautification parameter.

Optionally, the part feature recognition parameter corresponds to a corresponding part and a corresponding part feature, the part comprises any part of a head or a limb, the part feature comprises a wearing feature, a color feature, and a texture feature, and a target sub-element of the target component is at least one of a granular element or a blocky element.

According to the technical solution in the embodiment of the disclosure, the at least one part feature recognition parameter of the target object is determined, so that the feature is extracted from the part of the target object. The target component corresponding to the at least one part feature recognition parameter and the display information of the target component are determined, so as to obtain the at least one component for subsequent splicing and the display information required for displaying these components. The at least one target component is spliced, the virtual object to be adjusted corresponding to the target object is determined, and the target component is spliced and combined, so as to obtain an initial virtual object. The target virtual object is determined based on the display information of the at least one target component and the virtual object to be adjusted and displayed. Therefore, the problem of a large storage occupancy and a lack of adaption to terminal devices with various memories in the process of determining the target virtual object is solved. The storage space is saved, the model diversity is improved, and the user experience is improved.

The apparatus for determining a display object according to the embodiment of the disclosure may execute the method for determining a display object according to any embodiment of the disclosure, has the corresponding function modules for executing the method, and exerts the effect.

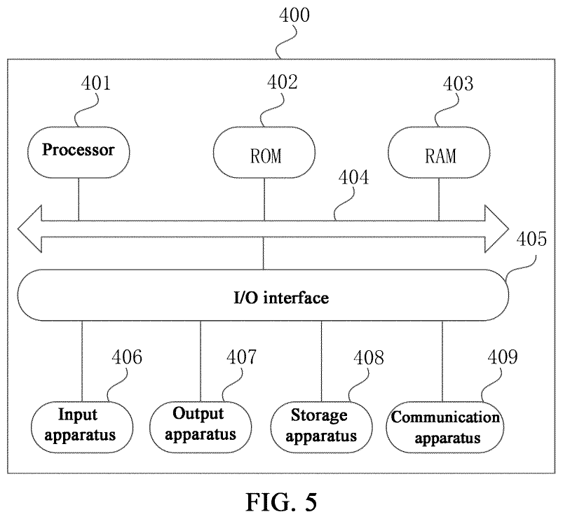

FIG. 5 is a schematic structural diagram of an electronic device according to an embodiment of the disclosure. With reference to FIG. 5 below, a schematic structural diagram of an electronic device 400 (for example, a terminal device or a server in FIG. 5) suitable for implementing the embodiment of the disclosure is shown. The terminal device in the embodiment of the disclosure may comprise, but is not limited to, mobile terminals such as a mobile phone, a notebook computer, a digital broadcast receiver, a personal digital assistant (PDA), a portable android device (PAD), a portable media player (PMP), an in-vehicle terminal (for example, and an in-vehicle navigation terminal), and fixed terminals such as a digital television (TV) and a desktop computer. The electronic device shown in FIG. 5 is merely illustrative, and should not limit the functions and use scope in the embodiment of the disclosure in any way.

As shown in FIG. 5, the electronic device 400 may comprise a processor 401 (for example, a central processing unit and a graphic processor). The processor 401 may execute various suitable actions and processing according to a program stored in a read-only memory (ROM) 402 or loaded into a random access memory (RAM) 403 from a storage apparatus 408. The RAM 403 may also store various programs and data required for an operation of the electronic device 400. The processor 401, the ROM 402, and the RAM 403 are connected to one another through a bus 404. An input/output (I/O) interface 405 is also connected to the bus 404.

Typically, the I/O interface 405 may be connected to apparatuses as follows: an input apparatus 406 such as a touch screen, a touch pad, a keyboard, a mouse, a camera, a microphone, an accelerometer, and a gyroscope; an output apparatus 407 such as a liquid crystal display (LCD), a speaker, and a vibrator; a storage apparatus 408 such as a magnetic tape and a hard disc; and a communication apparatus 409. The communication apparatus 409 may allow wireless or wired communication between the electronic device 400 and other devices for data exchange. Although FIG. 5 shows the electronic device 400 having various apparatuses, it should be understood that not all the apparatuses shown are required to be implemented or configured. More or fewer apparatuses may be implemented or configured alternatively.

Particularly, the processes described above with reference to the flowcharts may be implemented as computer software programs according to the embodiment of the disclosure. For example, a computer program product is provided in an embodiment of the disclosure. The computer program product comprises a computer program carried on a non-transitory computer-readable medium and encompassing a program code configured to execute the method shown in the flowchart. In such an embodiment, the computer program may be downloaded and installed via a network through the communication apparatus 409, installed via the storage apparatus 408, or installed via the ROM 402. The computer program executes the above functions defined in the method in the embodiment of the disclosure when executed by the processor 401.

The electronic device according to the embodiment of the disclosure and the method for determining a display object according to the embodiment above belongs to the same concept, so that reference may be made to the embodiment above for the technical details not described in detail in the embodiment, and the embodiment has the same effect as the embodiment above.

A computer-readable storage medium is provided in an embodiment of the disclosure. The computer-readable storage medium stores a computer program, where the computer program, when executed by a processor, implements the method for determining a display object according to the embodiment above.

It should be noted that the computer-readable storage medium above of the disclosure may be a computer-readable signal medium, a computer-readable storage medium, or any combinations of the above. The computer-readable storage medium may comprise, but is not limited to, an electronic, magnetic, optical, electromagnetic, infrared, or semiconductor system, apparatus, or device, or any combinations of the above. Instances of the computer-readable storage medium may comprise, but are not limited to, a portable computer magnetic disc, a hard disc, a random access memory (RAM), a read-only memory (ROM), an erasable programmable read-only memory (EPROM), a flash memory, an optical fiber, a portable compact disc read-only memory (CD-ROM), an optical storage device, and a magnetic storage device that are each electrically connected through at least one wire, or any suitable combinations of the above. In the disclosure, the computer-readable storage medium may be any tangible medium that encompasses or stores a program. The program may be used by or in connection with an instruction execution system, apparatus, or device. In the disclosure, however, the computer-readable signal medium may comprise a data signal propagated in a baseband or as part of a carrier wave, having a computer-readable program code carried thereon. Such a propagated data signal may take various forms comprising, but not limited to, an electromagnetic signal, an optical signal, or any suitable combinations of the above. The computer-readable signal medium may also be any computer-readable storage medium except for the computer-readable storage medium, and may send, propagate, or transmit a program to be used by or in connection with the instruction execution system, apparatus, or device. The program codes encompassed on the computer-readable storage medium may be transmitted via any suitable medium, comprising, but not limited to: a wire, an optic cable, a radio frequency (RF), etc., or any suitable combinations of the above.

In some embodiments, clients and servers can communicate with each other via any network protocol currently known (such as a hypertext transfer protocol (HTTP)) or any network protocol to be developed in the future, and can be interconnected to digital data communication (for example, a communication network) in any form or medium. Instances of the communication network comprise a local area network (LAN), a wide area network (WAN), the Internet, a peer-to-peer network (for example, an ad hoc peer-to-peer network), and any network currently known or to be developed in the future.

The computer-readable storage medium above may be encompassed in the electronic device above, or exist alone without being assembled into the electronic device.

The computer-readable medium above carries at least one program. When executed by the electronic device, the at least one program above causes the electronic device to:
determine at least one part feature recognition parameter of a target object;
determine a target component corresponding to the at least one part feature recognition parameter and display information of the target component, wherein a part type of the target component corresponds to a target part type in the part feature recognition parameter;
determine a virtual object to be adjusted corresponding to the target object by splicing at least one target component; and
determine a target virtual object based on display information of the at least one target component and the virtual object to be adjusted and display the target virtual object.

The computer program code configured to execute operations of the disclosure can be written in at least one programming language or their combinations. The programming language above comprises, but is not limited to, object-oriented programming languages, such as Java, Smalltalk, and C++, and conventional procedural programming languages, such as “C” language. The program code can be executed on a user's computer in all or in part, executed as an independent software package, executed on the user's computer in part and on a remote computer in part, or executed on the remote computer or a server in all. In a case involving the remote computer, the remote computer can be connected to the user's computer through any kind of network, comprising the local area network (LAN) or the wide area network (WAN), or can be connected to an external computer (for example, through the Internet based on an Internet service provider).

The flowcharts and block diagrams in the accompanying drawings illustrate possibly-implementable system architectures, functions, and operations of the systems, methods, and computer program products according to various embodiments of the disclosure. In this regard, each block in the flowcharts or the block diagrams can represent a module, a program segment, or a code segment, which encompasses at least one executable instruction configured to implement specified logical functions. It should also be noted that in some alternative embodiments, the functions noted in the blocks can also occur in an order other than those noted in the accompanying drawings. For example, two blocks represented in succession can in fact be executed substantially in parallel or in a reverse order sometimes, depending on the functions involved. It should also be noted that each block in the block diagrams and/or the flowcharts and combinations of blocks in the block diagrams and/or the flowcharts can be implemented through specific hardware-based systems that execute the specified functions or operations, or can be implemented through combinations of specific hardware and computer instructions.

The unit involved in the embodiment of the disclosure can be implemented through software or hardware. The name of the unit is not intended to define the unit itself. For example, the parameter determination module may also be described as “a module configured to obtain a part feature recognition parameter”.

The above-described functions herein may be executed, at least in part, by at least one hardware logical member. For example, non-restrictively, illustrative types of usable hardware logical members comprise: a field programmable gate array (FPGA), an application specific integrated circuit (ASIC), application specific standard parts (ASSPs), a system on chip (SOC), a complex programmable logic device (CPLD), etc.

In the context of the disclosure, a machine-readable storage medium can be a tangible medium that can encompass or store a program to be used by or in combination with the instruction execution system, apparatus, or device. The machine-readable storage medium can be a machine-readable signal medium or a machine-readable storage medium. The machine-readable storage medium can comprise, but is not limited to, an electronic, magnetic, optical, electromagnetic, infrared, or semiconductor system, apparatus, or device, or any suitable combinations of the above. Instances of the machine-readable storage medium comprise a portable computer disc, a hard disc, a random access memory (RAM), a read-only memory (ROM), an erasable programmable read-only memory (EPROM), a flash memory, an optical fiber, a portable compact disc read-only memory (CD-ROM), an optical storage device, and a magnetic storage device that are each electrically connected through at least one wire, or any suitable combinations of the above.

According to at least one embodiment of the disclosure, a method for determining a display object is provided in [Example 1]. The method comprises:
at least one part feature recognition parameter of a target object is determined;
a target component corresponding to the at least one part feature recognition parameter and display information of the target component are determined, wherein a part type of the target component corresponds to a target part type in the part feature recognition parameter;
at least one target component is spliced to determine a virtual object to be adjusted corresponding to the target object; and
a target virtual object is determined based on display information of the at least one target component and the virtual object to be adjusted, and then is displayed.

According to at least one embodiment of the disclosure, a method for determining a display object is provided in [Example 2], where
optionally, the step that at least one part feature recognition parameter of a target object is determined comprises:
an image to be processed is processed based on a parameter analysis model, and the at least one part feature recognition parameter is determined; wherein
the image to be processed comprises the target object.

According to at least one embodiment of the disclosure, a method for determining a display object is provided in [Example 3], where
optionally, the step that a target component corresponding to the at least one part feature recognition parameter is determined comprises:
a corresponding target component identifier is determined based on the at least one part feature recognition parameter; and
corresponding target sub-elements are retrieved based on the target component identifier, the target sub-elements are spliced to determine the target component corresponding to the target component identifier.

According to at least one embodiment of the disclosure, a method for determining a display object is provided in [Example 4], where
optionally, the step that a corresponding target component identifier is determined based on the at least one part feature recognition parameter comprises:
the target component identifier corresponding to the at least one part feature recognition parameter is determined based on a pre-established mapping relation; where
the mapping relation comprises the part type and a component identifier of at least one display state associated with the part type, and the part feature recognition parameter comprises the target part type and a corresponding target display state.

According to at least one embodiment of the disclosure, a method for determining a display object is provided in [Example 5], where
optionally, the step that the target sub-elements are spliced to determine the target component corresponding to the target component identifier comprises:
preset sub-element splicing parameters corresponding to the target sub-elements are obtained, wherein the sub-element splicing parameters comprise a rotation parameter, a position parameter, and a size parameter; and
the corresponding target sub-elements are spliced based on the sub-element splicing parameters of the target sub-elements to obtain the target component.

According to at least one embodiment of the disclosure, a method for determining a display object is provided in [Example 6], where
optionally, the step that at least one target component is spliced to determine a virtual object to be adjusted corresponding to the target object comprises:
a preset splicing parameter of the at least one target component is obtained, the at least one target component is spliced based on the splicing parameter to determine the virtual object to be adjusted.

According to at least one embodiment of the disclosure, a method for determining a display object is provided in [Example 7], where

Optionally, prior to the step that a target virtual object is determined based on display information of the at least one target component and the virtual object to be adjusted, and is displayed, the method further comprises:
texture information and color information corresponding to the at least one part feature recognition parameter is determined as the display information based on a mapping relation; wherein
the mapping relation comprises the color information and the texture information corresponding to the part feature recognition parameter.

According to at least one embodiment of the disclosure, a method for determining a display object is provided in [Example 8], where optionally, the method further comprises:
a target sub-element, corresponding to the display information, of a corresponding target component is determined as a sub-element to be filled, and the sub-element to be filled is filled based on the display information.

According to at least one embodiment of the disclosure, a method for determining a display object is provided in [Example 9], where
optionally, prior to the step that a target virtual object is determined based on display information of the at least one target component and the virtual object to be adjusted, and is displayed, the method comprises:
a sub-element to be filled of the corresponding target component is filled with the display information to obtain the target virtual object.

According to at least one embodiment of the disclosure, a method for determining a display object is provided in [Example 10], where optionally, a method for determining the display information comprises:
the display information is obtained in a case where the part feature recognition parameter comprises the display information; and
an associated part type associated with the target part type in the part feature recognition parameter is determined in a case where the part feature recognition parameter does not comprise the display information, so as to determine display information of the target part type according to a part feature recognition parameter of the associated part type.

According to at least one embodiment of the disclosure, a method for determining a display object is provided in [Example 11], where optionally, the method further comprises:
a preset beautification parameter is obtained in response to receiving a beautification instruction, so as to beautify a corresponding part based on the beautification parameter.

According to at least one embodiment of the disclosure, a method for determining a display object is provided in [Example 12], where
optionally, the part feature recognition parameter corresponds to a corresponding part and a corresponding part feature, the part comprises any part of a head or a limb, the part feature comprises a wearing feature, a color feature, and a texture feature, and a target sub-element of the target component is at least one of a granular element or a blocky element.

According to at least one embodiment of the disclosure, an apparatus for determining a display object is provided in [Example 13]. The apparatus comprises:
a parameter determination module configured to determine at least one part feature recognition parameter of a target object;
a component determination module configured to determine a target component corresponding to the at least one part feature recognition parameter and display information of the target component, wherein a part type of the target component corresponds to a target part type in the part feature recognition parameter;
a component splicing module configured to determine a virtual object to be adjusted corresponding to the target object by splicing at least one target component; and
a display module configured to determine a target virtual object based on display information of the at least one target component and the virtual object to be adjusted and display the target virtual object.

1. A method for determining a display object, comprising:
determining at least one part feature recognition parameter of a target object;
determining a target component corresponding to the at least one part feature recognition parameter and display information of the target component, wherein a part type of the target component corresponds to a target part type in the part feature recognition parameter;
determining a virtual object to be adjusted corresponding to the target object by splicing at least one target component;
determining a target virtual object based on display information of the at least one target component and the virtual object to be adjusted; and
displaying the target virtual object.

2. The method according to claim 1, wherein determining the at least one part feature recognition parameter of the target object comprises:
processing an image to be processed based on a parameter analysis model to determine the at least one part feature recognition parameter; and
wherein the image to be processed comprises the target object.

3. The method according to claim 1, wherein determining the target component corresponding to the at least one part feature recognition parameter comprises:
determining a corresponding target component identifier based on the at least one part feature recognition parameter; and
retrieving corresponding target sub-elements based on the target component identifier, and splicing the target sub-elements to determine the target component corresponding to the target component identifier.

4. The method according to claim 3, wherein determining the corresponding target component identifier based on the at least one part feature recognition parameter comprises:
determining the target component identifier corresponding to the at least one part feature recognition parameter based on a pre-established mapping relation; and
wherein the mapping relation comprises the part type and a component identifier of at least one display state associated with the part type, and the part feature recognition parameter comprises the target part type and a corresponding target display state.

5. The method according to claim 3, wherein splicing the target sub-elements to determine the target component corresponding to the target component identifier comprises:
obtaining preset sub-element splicing parameters corresponding to the target sub-elements, wherein the sub-element splicing parameters comprise a rotation parameter, a position parameter, and a size parameter; and
splicing the corresponding target sub-elements based on the sub-element splicing parameters of the target sub-elements to obtain the target component.

6. The method according to claim 1, wherein determining the virtual object to be adjusted corresponding to the target object by splicing the at least one target component comprises:
obtaining a preset splicing parameter of the at least one target component, and splicing the at least one target component based on the splicing parameter to determine the virtual object to be adjusted.

7. The method according to claim 1, further comprising, prior to determining the target virtual object based on the display information of the at least one target component and the virtual object to be adjusted and displaying the target virtual object,
determining, based on a mapping relation, texture information and color information corresponding to the at least one part feature recognition parameter as the display information; and
wherein the mapping relation comprises the color information and the texture information corresponding to the part feature recognition parameter.

8. The method according to claim 7, further comprising:
determining a target sub-element, corresponding to the display information, of a corresponding target component as a sub-element to be filled, to fill the sub-element to be filled based on the display information.

9. The method according to claim 8, wherein determining the target virtual object based on the display information of the at least one target component and the virtual object to be adjusted and displaying the target virtual object comprises:
filling the sub-element to be filled on the corresponding target component with the display information to obtain the target virtual object.

10. The method according to claim 1, wherein determining the display information comprises:
obtaining the display information in a case where the part feature recognition parameter comprises the display information; and
determining, in a case where the part feature recognition parameter does not comprise the display information, an associated part type associated with the target part type in the part feature recognition parameter, so as to determine display information of the target part type according to a part feature recognition parameter of the associated part type.

11. The method according to claim 1, further comprising:
obtaining a preset beautification parameter in response to receiving a beautification instruction, to beautify a corresponding part based on the beautification parameter.

12. The method according to claim 1,
wherein the part feature recognition parameter corresponds to a corresponding part and a corresponding part feature, the part comprises any part of a head or a limb, the part feature comprises a wearing feature, a color feature, and a texture feature, and a target sub-element of the target component is at least one of a granular element or a blocky element.

13. (canceled)

14. An electronic device, comprising:
at least one processor; and
a storage apparatus configured to store at least one program; and
wherein the at least one program, when executed by the at least one processor, causes the at least one processor to: implement the method for determining a display object according to any
determine at least one part feature recognition parameter of a target object;
determine a target component corresponding to the at least one part feature recognition parameter and display information of the target component, wherein a part type of the target component corresponds to a target part type in the part feature recognition parameter;
determine a virtual object to be adjusted corresponding to the target object by splicing at least one target component;
determine a target virtual object based on display information of the at least one target component and the virtual object to be adjusted; and
displaying the target virtual object.

15. A non-transitory readable storage medium, containing a computer program, wherein the computer program, when executed by a computer processor, causes the computer processor to:
determine at least one part feature recognition parameter of a target object;
determine a target component corresponding to the at least one part feature recognition parameter and display information of the target component, wherein a part type of the target component corresponds to a target part type in the part feature recognition parameter;
determine a virtual object to be adjusted corresponding to the target object by splicing at least one target component;
determine a target virtual object based on display information of the at least one target component and the virtual object to be adjusted; and
displaying the target virtual object.

16. The electronic device according to claim 14, wherein the at least one processor being caused to determine the at least one part feature recognition parameter of the target object comprises being caused to:
process an image to be processed based on a parameter analysis model to determine the at least one part feature recognition parameter; and
wherein the image to be processed comprises the target object.

17. The electronic device according to claim 14, wherein the at least one processor being caused to determine the target component corresponding to the at least one part feature recognition parameter comprises being caused to:
determine a corresponding target component identifier based on the at least one part feature recognition parameter; and
retrieve corresponding target sub-elements based on the target component identifier, and splice the target sub-elements to determine the target component corresponding to the target component identifier.

18. The electronic device according to claim 17, wherein the at least one processor being caused to determine the corresponding target component identifier based on the at least one part feature recognition parameter comprises being caused to:
determine the target component identifier corresponding to the at least one part feature recognition parameter based on a pre-established mapping relation; and
wherein the mapping relation comprises the part type and a component identifier of at least one display state associated with the part type, and the part feature recognition parameter comprises the target part type and a corresponding target display state.

19. The electronic device according to claim 17, wherein the at least one processor being caused to splice the target sub-elements to determine the target component corresponding to the target component identifier comprises being caused to:
obtain preset sub-element splicing parameters corresponding to the target sub-elements, wherein the sub-element splicing parameters comprise a rotation parameter, a position parameter, and a size parameter; and
splice the corresponding target sub-elements based on the sub-element splicing parameters of the target sub-elements to obtain the target component.

20. The electronic device according to claim 14, wherein the at least one processor being caused to determine the virtual object to be adjusted corresponding to the target object by splicing the at least one target component comprises being caused to:
obtain a preset splicing parameter of the at least one target component, and splice the at least one target component based on the splicing parameter to determine the virtual object to be adjusted.

21. The electronic device according to claim 14, wherein the at least one processor is further caused to, prior to determining the target virtual object based on the display information of the at least one target component and the virtual object to be adjusted and displaying the target virtual object,
determine, based on a mapping relation, texture information and color information corresponding to the at least one part feature recognition parameter as the display information; and
wherein the mapping relation comprises the color information and the texture information corresponding to the part feature recognition parameter.
